(19) United States
(12) Patent Application Publication
(10) Pub. No.: US 2019/0302012 A1
(43) Pub. Date: Oct. 3, 2019

(54) TERAHERTZ DETECTION METHOD AND SYSTEM FOR HIGH-RISK CHEMICAL IN ATMOSPHERE

(71) Applicant: Tsinghua University, Beijing (CN)

(72) Inventors: XIAO-PING ZHENG, Beijing (CN); HAO-HUA LI, Beijing (CN)

(73) Assignee: Tsinghua University, Beijing (CN)

(21) Appl. No.: 16/446,620

(22) Filed: Jun. 20, 2019

Related U.S. Application Data
(63) Continuation of application No. PCT/CN2018/092436, filed on Jun. 22, 2018.

(30) Foreign Application Priority Data
Dec. 13, 2017 (CN) 201711329777.2
Dec. 13, 2017 (CN) 201711329859.7
Dec. 13, 2017 (CN) 201711331516.4
Dec. 13, 2017 (CN) 201711331533.8
Dec. 13, 2017 (CN) 201711332668.6

(51) Int. Cl. G01N 21/3504; G01N 21/3586; G01N 21/94

(52) U.S. Cl. CPC G01N 21/3504; G01N 2021/3595; G01N 21/94; G01N 21/3586

(57) ABSTRACT

The present application discloses a terahertz based self-feedback system for detecting atmospheric high-risk chemical. In the system, a detecting device is configured to detect information of an atmospheric high-risk chemical. A mechanical adjusting device is configured to adjust a height and an orientation of the detecting device to obtain the information at different heights and orientations. A mobile carrying device is configured to drive the detecting device to move to obtain the information of the atmospheric high-risk chemical at different locations. A processing device is configured to process the information and feedback an instruction to adjust the height and the orientation of the detecting device and control the mobile carrying device to move. The processing device is also configured for imaging the information of the atmospheric high-risk chemical. The present application also discloses terahertz based methods for detecting a distribution and a leakage source of the atmospheric high-risk chemical.

### CROSS-REFERENCE TO RELATED APPLICATIONS

This application claims all benefits accruing under 35 U.S.C. § 119 from China Patent Application No. 201711331533.8, No. 201711329777.2, No. 201711332668.6, No. 201711329859.7, and No. 201711331516.4, all filed on Dec. 13, 2017 in the State Intellectual Property Office of China, the contents of which are hereby incorporated by reference. This application is a continuation under 35 U.S.C. § 120 of international patent application PCT/CN2018/092436 filed on Jun. 22, 2018, the content of which is also hereby incorporated by reference.

### FIELD

The present application relates to the field of environmental safety, and in particular to terahertz based methods and self-feedback systems for detecting atmospheric high-risk chemical.

### BACKGROUND

One or more toxic high-risk chemicals with unclear ingredients may be spread in the atmosphere at the site of an explosion or a terrorist attack. The difficulty of determining the ingredients, the source, and the spreading path of the toxic gas under a complex on-site situation delays effectively and promptly formulating of an evacuation procedure and a suppressing method of the toxic gas, causing a great loss of people's life and property, and bringing many problems in tracking and suppressing the toxic source.

In related art, systems for detecting atmospheric high-risk chemicals are limited to calibration and measurement of species and concentration of the high-risk chemicals, which are not possible to comprehensively measure and visualize a distribution of the atmospheric high-risk chemical leakage information in the leaked area. Therefore, it is difficult to help personnel to promptly formulate the crowd evacuation procedure and the suppressing method of the atmospheric high-risk chemical source.

### SUMMARY

What is needed, therefore, is a method and a system for detecting atmospheric high-risk chemical based on terahertz, so as to comprehensively measure and visualize the distribution of atmospheric high-risk chemical leakage information in the leakage area, and help personnel to quickly establish the atmospheric high-risk chemical suppression procedure and the evacuation procedure.

A terahertz based self-feedback system for detecting atmospheric high-risk chemical, comprising:

a detecting device, configured to detect information of an atmospheric high-risk chemical;

a mechanical adjusting device coupled to the detecting device, the mechanical adjusting device is configured to adjust a height and an orientation of the detecting device to obtain the information of the atmospheric high-risk chemical at different heights and orientations; a mobile carrying device, configured to carry the mechanical adjusting device, and to drive the detecting device to move in a space to obtain the information of the atmospheric high-risk chemical at different locations; and a processing device, configured to process the information of the atmospheric high-risk chemical detected by the detecting device, to feedback an instruction thereby controlling the mechanical adjusting device to adjust the height and the orientation of the detecting device, and thereby controlling the mobile carrying device to move, according to a processing result of the information of the atmospheric high-risk chemical; and the processing device being configured for imaging the information of the atmospheric high-risk chemical.

In one embodiment of the terahertz based self-feedback system, the detecting device comprises a transmissive type terahertz time domain system.

In one embodiment of the terahertz based self-feedback system, the detecting device further comprises an air humidity detector.

In one embodiment of the terahertz based self-feedback system, the terahertz time domain system comprises a sampling chamber in communication with an outside environment, the terahertz time domain system is configured to detect the atmospheric high-risk chemical in the sampling chamber and obtain the information of the atmospheric high-risk chemical.

In one embodiment of the terahertz based self-feedback system, the mobile carrying device comprises a housing, the mechanical adjusting device is mounted on the mobile carrying device, and the processing device is located in the housing.

In one embodiment of the terahertz based self-feedback system, the mechanical adjusting device comprises a height adjusting bracket and a cantilever, the height adjusting bracket is coupled to the mobile carrying device, and one end of the cantilever is coupled to the height adjusting bracket, and another end of the cantilever is coupled to the detecting device.

In one embodiment of the terahertz based self-feedback system, the height adjusting bracket is coupled to the cantilever through a slot defined by the height adjusting bracket and a spring disposed in the slot, the spring and the slot are configured to vertically move the cantilever, thereby varying a height level of the detecting device.

In one embodiment of the terahertz based self-feedback system, the height adjusting bracket is coupled to the mobile carrying device through a rotating shaft.

In one embodiment of the terahertz based self-feedback system, the rotating shaft is configured to be rotated 360°, thereby rotating, by 360°, the height adjusting bracket and the detecting device coupled thereto through the cantilever around the rotating shaft.

In one embodiment of the terahertz based self-feedback system, the processing device comprises a data processing module and a control module, and the operation performed by the data processing module comprises a sort operation, a leakage source determination operation, a data fitting operation, an image superposing operation, and a coordinate coincidence determination operation on the information of the atmospheric high-risk chemical, and the control module is configured to send an instruction to the detecting device according to a processing result of the data processing module, and send an instruction to drive the detecting device to move.

A terahertz based method for detecting a distribution of an atmospheric high-risk chemical, the method comprising:

obtaining concentration distribution information of an atmospheric high-risk chemical at a current detecting location by a detecting device;

obtaining a target detecting location according to the concentration distribution information of the atmospheric high-risk chemical, and driving the detecting device to reach the target detecting location;

obtaining the concentration distribution information of the atmospheric high-risk chemical at the target detecting location by the detecting device;

obtaining a next target detecting location according to the concentration distribution information of the atmospheric high-risk chemical at a current target detecting location, and driving the detecting device to reach the next target detecting location, until coordinates of the next target detecting location coincide with the coordinates of any of previous detecting locations, thereby obtaining the concentration distribution information of the atmospheric high-risk chemical at a plurality of detecting locations; and

transmitting the concentration distribution information to a data processing system to process the concentration distribution information of the atmospheric high-risk chemical at the plurality of detecting locations, thereby obtaining a spatial distribution image of the atmospheric high-risk chemical.

In one embodiment of the terahertz based method for detecting the distribution of the atmospheric high-risk chemical, the detecting device is a terahertz time domain system.

In one embodiment of the terahertz based method for detecting the distribution of the atmospheric high-risk chemical, the terahertz time domain system is a transmissive type terahertz time domain system.

In one embodiment of the terahertz based method for detecting the distribution of the atmospheric high-risk chemical, the obtaining the target detecting location comprises:

sorting all the obtained concentration distribution information in the three-dimensional space at the current detecting location, obtaining a highest concentration point in the three-dimensional space, and determining a direction of the highest concentration point as a traveling direction of the detecting device.

In one embodiment of the terahertz based method for detecting the distribution of the atmospheric high-risk chemical, the sorting all the obtained concentration distribution information in the three-dimensional space at the current detecting location comprises:

using a bubble sorting algorithm to sort all the obtained concentration distribution information in the three-dimensional space at the current detecting location.

In one embodiment of the terahertz based method for detecting the distribution of the atmospheric high-risk chemical, the obtaining the target detecting location according to the concentration distribution information of the atmospheric high-risk chemical, and driving the detecting device to reach the target detecting location further comprises:

averaging the concentration distribution information at the same height to obtain average concentrations at different heights at the current detecting location, and obtaining a maximum average concentration in the obtained average concentrations, and determining the height corresponding to the maximum average concentration as a target height z for the detecting device;

sorting the concentrations at different angles at the target height, determining an angle corresponding to a maximum concentration at the target height as a target angle for the driving device; and

driving the detecting device in a direction having the target height and the target angle to reach the target detecting location.

In one embodiment of the terahertz based method for detecting the distribution of the atmospheric high-risk chemical, the transmitting the concentration distribution information to a data processing system to process the concentration distribution information of the atmospheric high-risk chemical at the plurality of detecting locations, thereby obtaining a spatial distribution image of the atmospheric high-risk chemical comprises:

sending a plurality sets of concentration information corresponding to the three-dimensional coordinates of the certain atmospheric high-risk chemical to a numerical fitting system for numerical fitting, and obtaining a continuously distributed concentration information corresponding to the three-dimensional coordinates of the certain atmospheric high-risk chemical; and

identifying the continuously distributed concentration information corresponding to the three-dimensional coordinates to obtain a spatial distribution image of the certain atmospheric high-risk chemical.

In one embodiment of the terahertz based method for detecting the distribution of the atmospheric high-risk chemical, after the obtaining the spatial distribution image of the atmospheric high-risk chemical according to the concentration distribution information of the atmospheric high-risk chemical at the current location and the concentration distribution information of the atmospheric high-risk chemical at the target detecting locations, the method further comprises:

respectively detecting different species of the atmospheric high-risk chemicals through different detecting devices to obtain spatial distribution images of the different species of the atmospheric high-risk chemicals; and superposing the spatial distribution images of the different species of the atmospheric high-risk chemicals to obtain a spatial distribution superposed image of the different species of the atmospheric high-risk chemicals, and outputting the spatial distribution superposed image of the different species of the atmospheric high-risk chemicals.

In one embodiment of the terahertz based method for detecting the distribution of the atmospheric high-risk chemical, the identifying is coloring the continuously distributed concentration information corresponding to the three-dimensional coordinates in different colors.

A terahertz based method for detecting a single leakage source of a high-risk chemical, the method comprising:

obtaining concentration distribution information of an atmospheric high-risk chemical at a current detecting location by a detecting device;

obtaining a target detecting location according to the concentration distribution information of the atmospheric high-risk chemical, and driving the detecting device to reach the target detecting location;

obtaining the concentration distribution information of the atmospheric high-risk chemical at a current target detecting location by the detecting device, obtaining a next target detecting location according to the concentration distribution information of the atmospheric high-risk chemical at the current target detecting location, and driving the detecting device to reach the next detecting location, until a concentration of the atmospheric high-risk chemical at the next target detecting location reaches a maximum value; and obtaining a spatial distribution image of the atmospheric high-risk chemical according to the concentration distribution information of the atmospheric high-risk chemical at the current detecting location and the target detecting locations.

In one embodiment of terahertz based method for detecting a single leakage source of a high-risk chemical, the obtaining the target detecting location according to the concentration distribution information of the atmospheric high-risk chemical, and driving the detecting device to reach the target detecting location comprises:

sorting all the obtained concentration distribution information in the three-dimensional space at the current location to obtain a direction of the maximum concentration in the three-dimensional space, and determining the direction of the maximum concentration as a traveling direction of the detecting device; and driving the detecting device in the traveling direction to reach the target detecting location.

In one embodiment of terahertz based method for detecting a single leakage source of a high-risk chemical, the sorting all the obtained concentration distribution information in the three-dimensional space at the current location comprises:

using a bubble sorting algorithm to sort all the obtained concentration distribution information in the three-dimensional space of the current location.

In one embodiment of terahertz based method for detecting a single leakage source of a high-risk chemical, the obtaining the target detecting location according to the concentration distribution information of the atmospheric high-risk chemical, and driving the detecting device to reach the target detecting location further comprises:

averaging the concentration distribution information at the same height to obtain average concentrations at different heights at the current location, and obtaining a maximum average concentration in the obtained average concentrations, and determining the height corresponding to the maximum average concentration as a target height;

sorting the concentrations at different angles at the target height, determining an angle corresponding to a maximum concentration at the target height as a target angle; and

driving the detecting device in a direction having the target height and the target angle to reach the target detecting location.

In one embodiment of terahertz based method for detecting a single leakage source of a high-risk chemical, the obtaining the next target detecting location according to the concentration distribution information of the atmospheric high-risk chemical at the current target detecting location; and driving the detecting device to reach the next detecting location, until the concentration of the atmospheric high-risk chemical at the next target detecting location reaches a maximum value comprises:

comparing the maximum concentrations of the atmospheric high-risk chemical at the current location and at two next target detecting locations directly after the current location; and

when the maximum concentrations of the atmospheric high-risk chemical at the two next target detecting locations directly after the current location are both smaller than the maximum concentration of the atmospheric high-risk chemical at the current location, determining the current location as the leakage source of the atmospheric high-risk chemical.

In one embodiment of terahertz based method for detecting a single leakage source of a high-risk chemical, the obtaining the spatial distribution image of the atmospheric high-risk chemical according to the concentration distribution information of the atmospheric high-risk chemical at the current detecting location and the concentration distribution information of the atmospheric high-risk chemical at the target detecting locations comprises:

numerical fitting the concentration distribution information of the atmospheric high-risk chemical at the current detecting location and the concentration distribution information of the atmospheric high-risk chemical at the target detecting locations to obtain a continuously distributed concentration information corresponding to the three-dimensional coordinates of the certain atmospheric high-risk chemical; and

identifying the continuously distributed concentration information by concentration to obtain a spatial distribution image of the atmospheric high-risk chemical.

In one embodiment of terahertz based method for detecting a single leakage source of a high-risk chemical, after the obtaining the spatial distribution image of the atmospheric high-risk chemical according to the concentration distribution information of the atmospheric high-risk chemical at the current detecting location and the concentration distribution information of the atmospheric high-risk chemical at the target detecting locations, the method further comprises:

respectively detecting different species of the atmospheric high-risk chemicals through different detecting devices to obtain spatial distribution images of the different species of the atmospheric high-risk chemicals; and

superposing the spatial distribution images of the different species of the atmospheric high-risk chemicals to obtain a spatial distribution superposed image of the different species of the atmospheric high-risk chemicals, and outputting the spatial distribution superposed image of the different species of the atmospheric high-risk chemicals.

In one embodiment of terahertz based method for detecting a single leakage source of a high-risk chemical, the respectively detecting different species of the atmospheric high-risk chemical through different detecting devices to obtain the spatial distribution images of the different species of the atmospheric high-risk chemical further comprises:

color identifying the spatial distribution images of the different species of the atmospheric high-risk chemicals.

In one embodiment of terahertz based method for detecting a single leakage source of a high-risk chemical, after the respectively detecting different species of the atmospheric high-risk chemicals through different detecting devices to obtain the spatial distribution images of the different species of the atmospheric high-risk chemicals, the method further comprises:

determining concentration change information according to colors of the spatial distribution images of the different species of the atmospheric high-risk chemicals;

formulating an escape or evacuation direction according to the concentration change information; and

outputting an escaping or evacuating directive information according to the escape or evacuation direction.

A terahertz based method for determining a spatial distribution of atmospheric high-risk chemical, comprising:

obtaining concentration distribution information and a maximum concentration of an atmospheric high-risk chemical at a current detecting location by a terahertz detecting device;

obtaining a target detecting location according to the concentration distribution information of the atmospheric high-risk chemical, and driving the detecting device to reach the target detecting location;

obtaining the concentration distribution information and the maximum concentration of the atmospheric high-risk chemical at the target detecting location by the terahertz detecting device, obtaining a next target detecting location according to the concentration distribution information and the maximum concentration of the atmospheric high-risk chemical at a current target detecting location, and driving the terahertz detecting device to reach the next target detecting location;

obtaining location information of a leakage source of the atmospheric high-risk chemical according to the maximum concentrations at a plurality of the target detecting locations, when a relationship between the maximum concentrations at the plurality of target detecting locations satisfies a preset condition; and obtaining a spatial distribution image of the atmospheric high-risk chemical according to the concentration distribution information of the atmospheric high-risk chemical at the current location and the plurality of the target detecting locations, and according to the location information of the leakage source.

In one embodiment of the terahertz based method for determining a spatial distribution of atmospheric high-risk chemical, the obtaining the target detecting location according to the concentration distribution information of the atmospheric high-risk chemical, and driving the detecting device to reach the target detecting location comprises:

sorting all the obtained concentration distribution information in the three-dimensional space at the current location to obtain a direction of the maximum concentration in the three-dimensional space, and determining the direction of the maximum concentration as a traveling direction of the detecting device; and driving the detecting device in the traveling direction to reach the target detecting location.

In one embodiment of the terahertz based method for determining a spatial distribution of atmospheric high-risk chemical, the sorting all the obtained concentration distribution information in the three-dimensional space at the current location comprises:

using a bubble sorting algorithm to sort all the obtained concentration distribution information in the three-dimensional space of the current location.

In one embodiment of the terahertz based method for determining a spatial distribution of atmospheric high-risk chemical, the obtaining the target detecting location according to the concentration distribution information of the atmospheric high-risk chemical, and driving the detecting device to reach the target detecting location comprises:

averaging the concentration distribution information at the same height to obtain average concentrations at different heights at the current location, and obtaining a maximum average concentration in the obtained average concentrations, and determining the height corresponding to the maximum average concentration as a target height;

sorting the concentrations at different angles at the target height, determining an angle corresponding to a maximum concentration at the target height as a target angle; and

driving the detecting device in a direction having the target height and the target angle to reach the target detecting location.

In one embodiment of the terahertz based method for determining a spatial distribution of atmospheric high-risk chemical, a distance between two adjacent detecting locations detected by the detecting device is one step;

the obtaining the concentration distribution information and the maximum concentration of the atmospheric high-risk chemical at the target detecting location comprises:

the maximum concentration point in the range of one step in the three-dimensional coordinates of the target detecting location is detected by the detecting device as the concentration peak of the atmospheric high-risk chemical at the target detecting location.

In one embodiment of the terahertz based method for determining a spatial distribution of atmospheric high-risk chemical, the preset condition comprises:

comparing the maximum concentrations of the atmospheric high-risk chemical at the current location and at two next target detecting locations directly after the current location;

when the maximum concentrations of the atmospheric high-risk chemical at the two next target detecting locations directly after the current location are both smaller than the maximum concentration of the atmospheric high-risk chemical at the current location, determining the current location as the atmospheric high-risk chemical leakage source; or

when the maximum concentration of the atmospheric high-risk chemical at a first target detecting location after the current location is smaller than the maximum concentration of the atmospheric high-risk chemical at the current location, and the maximum concentration of the atmospheric high-risk chemical at the second target location after the current location is greater than the maximum concentration of the atmospheric high-risk chemical at the current location, then further comparing the maximum concentrations of the atmospheric high-risk chemical at the current location and at the third target detecting location after the current location;

when the maximum concentration of the atmospheric high-risk chemical at the third target detecting location after the current location is smaller than the maximum concentration of the atmospheric high-risk chemical at the current location, determining the current location as the atmospheric high-risk chemical leakage source.

In one embodiment of the terahertz based method for determining a spatial distribution of atmospheric high-risk chemical, the obtaining the spatial distribution image of the atmospheric high-risk chemical according to the concentration distribution information of the atmospheric high-risk chemical at the current location and the plurality of the target detecting locations, and according to the location information of the leakage source comprises:

numerical fitting the concentration distribution information of the atmospheric high-risk chemical at the current detecting location and the concentration distribution information of the atmospheric high-risk chemical at the target detecting locations to obtain a continuously distributed concentration information corresponding to the three-dimensional coordinates of the certain atmospheric high-risk chemical; and

identifying the continuously distributed concentration information by concentration to obtain a spatial distribution image of the atmospheric high-risk chemical.

In one embodiment of the terahertz based method for determining a spatial distribution of atmospheric high-risk chemical, after the obtaining the spatial distribution image of the atmospheric high-risk chemical according to the concentration distribution information of the atmospheric high-risk chemical at the current location and the plurality of the target detecting locations, and according to the location information of the leakage source, the method further comprises:

respectively detecting different species of the atmospheric high-risk chemicals through different detecting devices to obtain spatial distribution images of the different species of the atmospheric high-risk chemicals; and

superposing the spatial distribution images of the different species of the atmospheric high-risk chemicals to obtain a spatial distribution superposed image of the different species of the atmospheric high-risk chemicals, and outputting the spatial distribution superposed image of the different species of the atmospheric high-risk chemicals.

In one embodiment of the terahertz based method for determining a spatial distribution of atmospheric high-risk chemical, the respectively detecting different species of the atmospheric high-risk chemical through different detecting devices to obtain spatial distribution images of the different species of the atmospheric high-risk chemical comprises:

color identifying the spatial distribution images of the different species of the atmospheric high-risk chemicals;

determining concentration change information according to colors of the spatial distribution images of the different species of the atmospheric high-risk chemicals;

formulating an escape or evacuation direction according to the concentration change information; and

outputting an escaping or evacuating directive information according to the escape or evacuation direction.

A terahertz based method for detecting a plurality of leakage sources of an atmospheric high-risk chemical, comprising:

obtaining concentration distribution information of an atmospheric high-risk chemical at a current detecting location by a detecting device;

obtaining a target detecting location according to the concentration distribution information of the atmospheric high-risk chemical at the current detecting location, and driving the detecting device to reach the target detecting location;

obtaining the concentration distribution information of the atmospheric high-risk chemical at the target detecting location by the detecting device;

obtaining a next target detecting location according to the concentration distribution information of the atmospheric high-risk chemical at a current target detecting location, and obtaining the concentration distribution information of the atmospheric high-risk chemical at a plurality of detecting locations when the detecting device detects all leakage sources of a certain high-risk chemical in a detection area; and

transmitting the concentration distribution information at the plurality of detecting locations to a data processing system to process the concentration distribution information and obtaining a spatial distribution image of the atmospheric high-risk chemical.

In one embodiment of the terahertz based method for detecting a plurality of leakage sources of an atmospheric high-risk chemical, the obtaining the next target detecting location comprises:

sorting all the obtained concentration distribution information in the three-dimensional space to obtain a direction of the maximum concentration in the three-dimensional space, and determining the direction of the maximum concentration as a traveling direction of the detecting device; and

driving the detecting device in the traveling direction to reach the next target detecting location.

In one embodiment of the terahertz based method for detecting a plurality of leakage sources of an atmospheric high-risk chemical, the sorting all the obtained concentration distribution information in the three-dimensional space comprises:

using a bubble sorting algorithm to sort all the obtained concentration distribution information in the three-dimensional space.

In one embodiment of the terahertz based method for detecting a plurality of leakage sources of an atmospheric high-risk chemical, the obtaining the target detecting location according to the concentration distribution information of the atmospheric high-risk chemical at the current detecting location, and driving the detecting device to reach the target detecting location further comprises:

averaging the concentration distribution information at the same height to obtain average concentrations at different heights at the current location, and obtaining a maximum average concentration in the obtained average concentrations, and determining the height corresponding to the maximum average concentration as a target height;
sorting the concentrations at different angles at the target height, determining an angle corresponding to a maximum concentration at the target height as a target angle; and driving the detecting device in a direction having the target height and the target angle to reach the target detecting location.

In one embodiment of the terahertz based method for detecting a plurality of leakage sources of an atmospheric high-risk chemical, a method for determining that all the leak sources of the certain species of atmospheric high-risk chemical are obtained in the area comprises:

obtaining the next target detecting location according to the concentration distribution information of the atmospheric high-risk chemical at the target detecting location until the coordinates of the next target detecting location coincide with the coordinates of any of the previous detecting locations; and determining that all the leakage sources of a certain atmospheric high-risk chemical in the detection area are obtained by the detecting device.

In one embodiment of the terahertz based method for detecting a plurality of leakage sources of an atmospheric high-risk chemical, the obtaining the next target detecting location according to the concentration distribution information of the atmospheric high-risk chemical at the target detecting location until the coordinates of the next target detecting location coincide with the coordinates of any of the previous detecting locations comprises:

obtaining coordinates of a plurality of target detecting locations and storing the coordinates of the plurality of target detecting locations in the processing system;

the processing system analyzing the obtained coordinates of the plurality of target detecting locations; and

when the processing system detecting the coordinates of the next target detecting location coincides with the coordinates of any of the previous target detecting locations, the processing system sending a stop command, and the detecting device stopping the detecting.

In one embodiment of the terahertz based method for detecting a plurality of leakage sources of an atmospheric high-risk chemical, the steps of determining that the detecting device has reached an atmospheric high risk chemical leakage source comprises:

comparing the maximum concentrations of the atmospheric high-risk chemical at the current location and at two next target detecting locations directly after the current location; and

when the maximum concentrations of the atmospheric high-risk chemical at the two next target detecting locations directly after the current location are both smaller than the maximum concentration of the atmospheric high-risk chemical at the current location, determining the current location as the leakage source of the atmospheric high-risk chemical.

In one embodiment of the terahertz based method for detecting a plurality of leakage sources of an atmospheric high-risk chemical, the transmitting the concentration distribution information at the plurality of detecting locations to the data processing system to process the concentration distribution information and obtaining the spatial distribution image of the atmospheric high-risk chemical comprises:

numerical fitting the concentration distribution information at the plurality of detecting locations to obtain a continuously distributed concentration information corresponding to the three-dimensional coordinates of the certain atmospheric high-risk chemical; and identifying the continuously distributed concentration information by concentration to obtain the spatial distribution image of the atmospheric high-risk chemical.

In one embodiment of the terahertz based method for detecting a plurality of leakage sources of an atmospheric high-risk chemical, after the obtaining the spatial distribution image of the atmospheric high-risk chemical, the method further comprises:

respectively detecting different species of the atmospheric high-risk chemicals through different detecting devices to obtain spatial distribution images of the different species of the atmospheric high-risk chemicals; and superposing the spatial distribution images of the different species of the atmospheric high-risk chemicals to obtain a spatial distribution superposed image of the different species of the atmospheric high-risk chemicals, and outputting the spatial distribution superposed image of the different species of the atmospheric high-risk chemicals.

A computer readable storage medium having a computer program stored therein, wherein the program, when executed by a processing device, is capable of implementing the steps of any of the above-described methods.

Details of one or more embodiments of the present disclosure will be clear in the accompanying drawings and description below. Other features, purposes, and advantages of the present disclosure will be apparent from the description and appended claims.

### BRIEF DESCRIPTION OF THE DRAWINGS

Implementations are described by way of example only with reference to the attached figures.

FIG. 1 is a schematic view of one embodiment of a terahertz based self-feedback system for detecting atmospheric high-risk chemical;

FIG. 2 is a structural view of one embodiment of a height adjusting bracket and a cantilever;

FIG. 3 is a structural view of one embodiment of a transmissive type terahertz time domain system;

FIG. 4 shows a flow chart of one embodiment of a terahertz based method for detecting concentration distribution of atmospheric high-risk chemical;

FIG. 5 shows a flow chart of one embodiment of a terahertz based method for detecting a single high-risk chemical leakage source;

FIG. 6 shows a flow chart of one embodiment of a method for determining that a detecting device has reached a leakage source;

FIG. 7 shows a flow chart of one embodiment of a method for detecting a plurality of high-risk chemical leakage sources;

FIG. 8 shows a flow chart of one embodiment of a method for detecting three kinds of atmospheric high-risk chemical a, b, and c, and setting a specific rotation angle of a rotating shaft and a specific height of the height adjusting bracket;

FIG. 9 shows a distribution diagram of a concentration detecting result of a high-risk chemical in one embodiment;

FIG. 10 shows a superposed overlay of concentration detecting results of a plurality of atmospheric high-risk chemical in one embodiment.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The present disclosure discloses embodiments of terahertz based method and system for detecting atmospheric high-risk chemical, so as to comprehensively measure and visualize a distribution of the atmospheric high-risk chemical leakage information in the leaked area, and help personnel to promptly formulate the suppressing method for the atmospheric high-risk chemical sources and the crowd evacuation procedure.

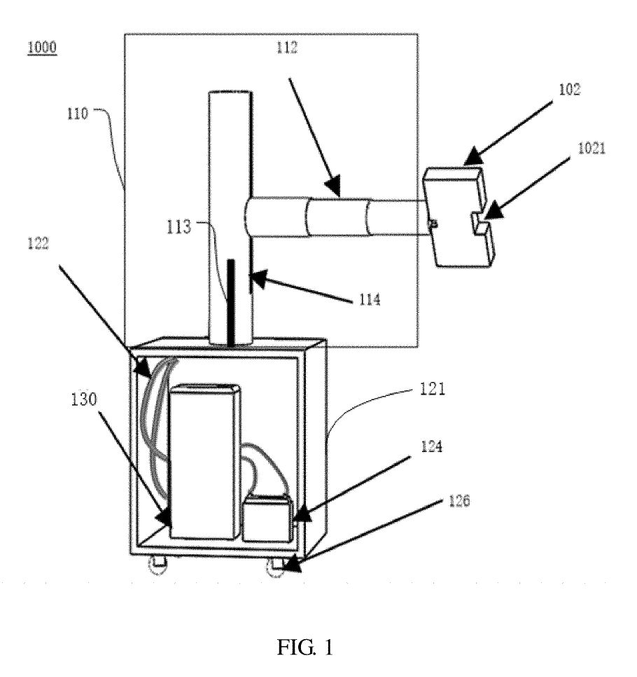

Referring to FIG. 1, one embodiment of a terahertz based self-feedback system 1000 for detecting atmospheric high-risk chemical comprises a detecting device 100, a mechanical adjusting device 110, a mobile carrying device 120, and a processing device 130.

The detecting device 100 is configured to detect information of an atmospheric high-risk chemical.

In one embodiment, the detecting device 100 is a device for sampling the atmospheric high-risk chemical and obtaining terahertz characteristics and/or information of the atmospheric high-risk chemical. The information of atmospheric high-risk chemical can comprise at least one of concentration information and species information of the atmospheric high-risk chemical.

The mechanical adjusting device 110 is coupled to the detecting device 100, and is configured to adjust a height and an orientation of the detecting device 100 to obtain the information of the atmospheric high-risk chemical at different heights and orientations.

The mechanical adjusting device 110 mechanically adjusts the location of the detecting device 100 according to an instruction of the processing device 130, including adjusting the height and orientation of the detecting device 100, thereby changing a three-dimensional coordinates (x, y, z) of the location of the detecting device 100. The three-dimensional coordinates can be the abscissa x, the ordinate y, and the applicate z. In one embodiment, the mechanical adjusting device adjusts the three-dimensional coordinates of the detecting device 100 to obtain a concentration distribution of the atmospheric high-risk chemical in different three-dimensional coordinates of a three-dimensional space, and generates a four-dimensional coordinates (n, a, b, c), wherein n is the concentration of the atmospheric high-risk chemical, a is the abscissa, b is the ordinate, and c is the applicate. For example, the detecting device 100 generates concentration distribution coordinates (n1, a1, b1, c1) at a location coordinates (x1, y1, z1), then x1=a1, y1=b1, and z1=c1.

The mobile carrying device 120 is configured to carry the mechanical adjusting device 110, and to drive the detecting device 100 to move in a space to obtain the information of the atmospheric high-risk chemical at different locations.

The mobile carrying device 120 can be mechanically coupled to the mechanical adjusting device 110. The mechanical adjusting device 110 can be disposed on the mobile carrying device 120 and move with the movement of the mobile carrying device 120. Similarly, the mechanical adjusting device 110 can be mechanically coupled to the detecting device 100 and move with the mobile carrying device 120. The mobile carrying device 120 carries the detecting device 100 and the mechanical adjusting device 110 to move in the space. The mobile carrying device 120 can move horizontally thereby having the detecting device 100 horizontally moved. Meanwhile, the mechanical adjusting device 110 can adjust the height and the orientation of the detecting device 100.

The processing device 130 is configured to process the information of the atmospheric high-risk chemical detected by the detecting device 100, and to feedback an instruction thereby controlling the mechanical adjusting device 110 to adjust the height and the orientation, and controlling the mobile carrying device 120 to move according to a processing result of the information of the atmospheric high-risk chemical. The processing device 130 is also configured to perform an imaging process on information of the atmospheric high-risk chemical.

The processing device 130 can be an information receiving center, an information analysis center, a feedback information generating center, an information transmitting center, and a control center, enabling the system to accurately detect the atmospheric high-risk chemical.

In one embodiment, the mobile carrying device 120 comprises a housing 121. The mechanical adjusting device 110 is mounted on the mobile carrying device 120, and the processing device 130 is located within the housing 121. Specifically, the mechanical adjusting device 110 can be coupled to the mobile carrying device 120 through a rotating shaft 113. The rotating shaft can be rotated 360°, thereby driving the mechanical adjusting device to perform a 360° rotation. For example, the rotating shaft 113 can be vertically arranged and rotated 360° in the horizontal plan to have the detecting device 100 detecting in different orientations, i.e., to obtain different coordinates (x, y). In one embodiment, the processing device 130 is disposed in the housing 121 which provides a protection to the processing device 130. The mobile carrying device 120 can comprise universal wheels 126, or a pulley, or other members to carry the mechanical adjusting device 110 and the detecting device 100 to different locations.

In one embodiment, the processing device 130 can comprise a data processing module and a control module. The operation performed by the data processing module can comprise a sort operation, a leakage source determination operation, a data fitting operation, an image superposing operation, and a coordinate coincidence determination operation on the information of the atmospheric high-risk chemical. The control module can be configured to send an instruction to the detecting device 100 according to a processing result of the data processing module, and send an instruction to drive the detecting device 100 to move.

In one embodiment, the detecting device 100 is a terahertz time domain system comprising a sampling chamber 1021 for the atmospheric high risk chemical.

In one embodiment, the system 1000 further comprises a feedback and instruction transmission wire 122 configured to receive the detected information from the detecting device 100, and to transmit the detected information to the processing device 130, and configured to receive the controlling instruction from the processing device 130, and to transmit the controlling instruction to the mobile carrying device 120 and the mechanical adjusting device 110 to control the movements thereof, such as the height of the rotating shaft 113.

The system 1000 can further comprise a power source 124 disposed on the mobile carrying device 120. The power source 124 can be a battery configured to provide power for the system 1000.

The detecting device 100 can comprise the terahertz time domain system. In one embodiment, the detecting device 100 can further comprise a transmissive type terahertz time domain system for detecting objects through terahertz waves.

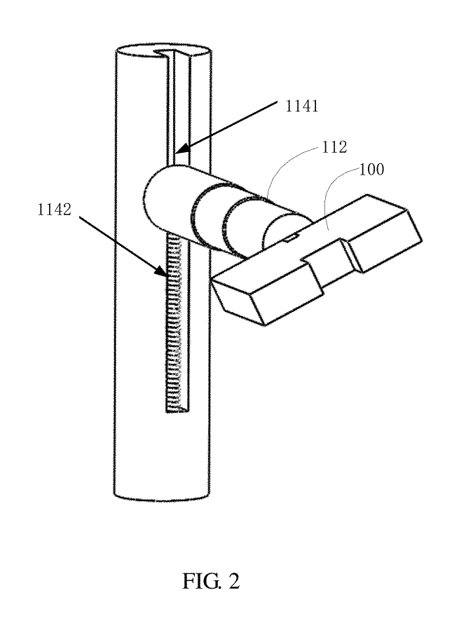

Referring to FIG. 2, in one embodiment, the mechanical adjusting device 110 comprises a telescopic, stretchable, or retractable height adjusting bracket 114 and a cantilever 112. The height adjusting bracket 114 can have a slot 1141 for mounting the cantilever 112 to the height adjusting bracket 114. A spring 1142 can be disposed in the slot 1141. The spring 1142 controls the height of the cantilever 112 through its own deformation, thereby varying the height level of the detecting device 110. The height adjusting bracket 114 can be coupled to the mobile carrying device 120 through the rotating shaft 113. One end of the cantilever 112 is coupled to the height adjusting bracket 114, and the other end of the cantilever 112 is coupled to the detecting device 100.

Optionally, the connecting manner of the height adjusting bracket 114 and the cantilever 112 is not limited to combination of the spring and the slot, and other connecting configuration capable of controlling the height of the cantilever 112 by the height adjusting bracket 114 can be adopted.

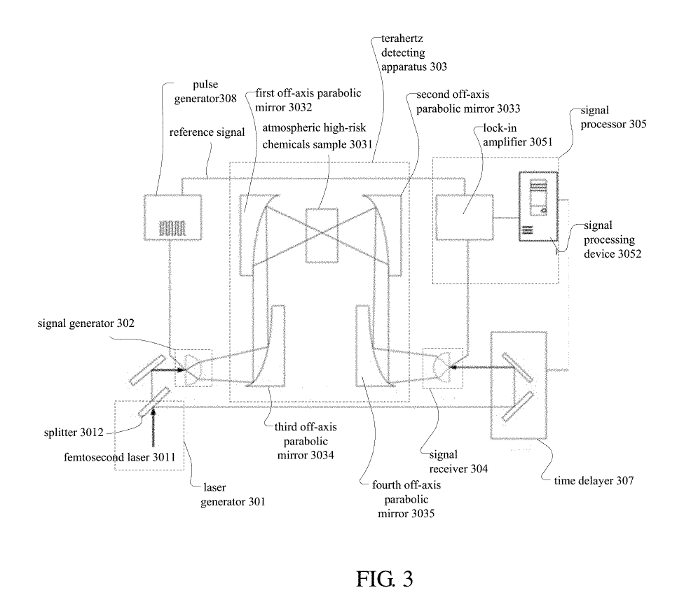

Referring to FIG. 3, one embodiment of the terahertz time domain system for detecting the atmospheric high-risk chemical can comprise:

a laser generator 301 configured to generate a pump pulse and a probe pulse;

a time delayer 307 configured to receive the pump pulse generated by the laser generator 301, and to regulate a time delay of the pump pulse and the probe pulse generated by the laser generator 301;

a signal generator 302 configured to emit a terahertz signal;

a terahertz detector 303 configured for sampling and detecting the atmospheric high-risk chemical in the environment;

a signal receiver 304 configured for receiving the terahertz signal after the terahertz signal passes through the sampling chamber 1021; and

a signal processing device 305 configured to analyze and process the received terahertz signal to obtain the information of the atmospheric high-risk chemical.

In an embodiment, the laser generator 301 comprises a femtosecond laser generator 3011 and a beam splitter 3012. The signal generator 302 comprises a lens for generating a terahertz signal. The terahertz detector 303 is configured to carry an atmospheric high-risk chemical sample 3031, a first off-axis parabolic mirror 3032, a second off-axis parabolic mirror 3033, a third off-axis parabolic mirror 3034, and a fourth off-axis parabolic mirror 3035. The first off-axis parabolic mirror 3032 is disposed opposite to the second off-axis parabolic mirror 3033, and the third off-axis parabolic mirror 3034 is disposed opposite to the fourth off-axis parabolic mirror 3035. The signal receiver 304 comprises a lens for receiving the terahertz signal. The signal processing device 305 comprises a lock-in amplifier 3051 and a signal processing device 3052.

In one embodiment, the femtosecond laser emitted by the femtosecond laser generator 3011 is split by the beam splitter 3012 into two pulses, the pump pulse and the probe pulse respectively. The pump pulse reaches the time delayer 307, passes through the time delayer 307, and then reaches the lock-in amplifier 3051. The two pulses, the terahertz pulse signal generated from the signal generator 302 and the probe pulse, sequentially pass through the third off-axis parabolic mirror 3034 and the first off-axis parabolic mirror 3032, and reach the atmospheric high-risk chemical sample 3031, to detect the atmospheric high-risk chemical sample 3031 and form a detection resulted signal. The detection resulted signal, which is the terahertz signal then reaches the signal receiver 304 via the second off-axis parabolic mirror 3033 and the fourth off-axis parabolic mirror 3035. The time delayer 307 regulates the time delay between the pump pulse and the probe pulse to change the times that the signals reach the terahertz detector. With different arrival times of the signals, the amount of change of the terahertz electric field strength with time can be measured. The signal processing device 3052 analyzes and processes the variation of the terahertz electric field with time, for example, performs a Fourier transform to obtain a transmission spectrum, and analyzes the obtained transmission spectrum to obtain the species and concentration information of the atmospheric high-risk chemical.

In one embodiment, the atmospheric high-risk chemical sample 3031 is placed in a sampling chamber 1021. The sampling chamber 1021 in the terahertz time domain system is fluid communicated with the outside environment. The terahertz time domain system is configured to detect the atmospheric high-risk chemical sample 3031 in the sampling chamber 1021 to obtain the information of the atmospheric high-risk chemical. In related technology, the atmospheric high-risk chemical is placed in an air-tight chamber for testing, which may cause a loss of terahertz waves during the passing of the chamber, and the material of the chamber may cause a delay of the spectrum, reducing the accuracy the detection result.

As it is often difficult to sample at the leakage or explosion site, and it is necessary to real-time obtain a real high-risk chemical sample and a concentration of the sample, the terahertz detector needs to be directly placed in the atmosphere of the site to perform a contact measurement.

In one embodiment, an air humidity detector is also mounted on the terahertz time domain system. Since an absorption of the terahertz signal by water vapor is very strong, a “difference method” can be adopted to eliminate the influence of water vapor on the detection result, comprising a step of subtracting the terahertz spectrum of the same concentration of water vapor previously stored in a database from the detected terahertz spectrum, in order to obtain the real terahertz spectrum information of the atmospheric high-risk chemical to be tested, for determining the type and the concentration information of the atmospheric high-risk chemical.

In one embodiment, the test time is 20 picoseconds (ps), and the terahertz wave in a band of 1 THz to 2 THz is used. The atmospheric humidity is tested by the air humidity detector to obtain an air relative humidity of 5%. An absorption spectrum of water in the 1 THz to 3 THz band when the relative humidity of air is 5% and the sampling time is 20 ps is read from the database. The characteristic spectrum of the atmospheric high-risk chemical can be obtained by subtracting the water spectrum from the measured spectrum. The frequency and the height of the peak of the fingerprint peaks in the characteristic spectrum are compared with the characteristic spectrums of known chemical species, and then the type and concentration of the atmospheric high-risk chemical in the real-time environment can be known and calculated.

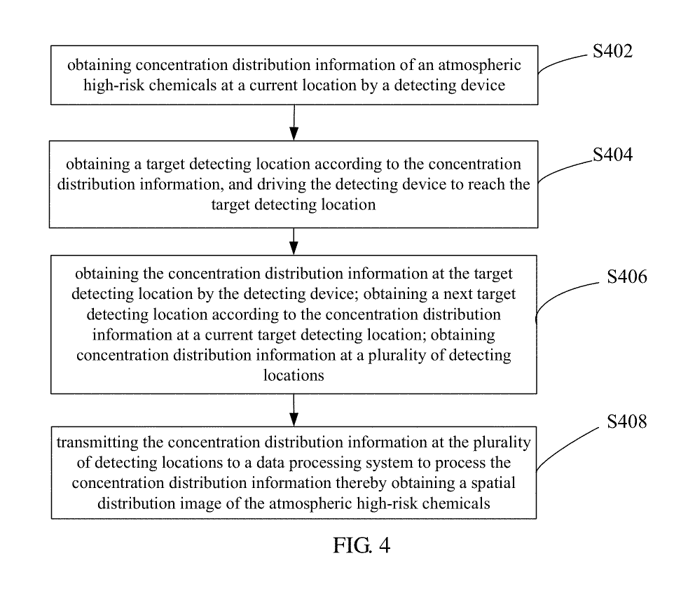

Referring to FIG. 4, one embodiment of a terahertz based method for detecting a high-risk chemical leakage source comprising:

S402, obtaining concentration distribution information of an atmospheric high-risk chemical at a current location by a detecting device;

S404, obtaining a target detecting location according to the concentration distribution information of the atmospheric high-risk chemical, and driving the detecting device to reach the target detecting location;

S406, obtaining the concentration distribution information of the atmospheric high-risk chemical at the target detecting location by the detecting device; obtaining a next target detecting location according to the concentration distribution information of the atmospheric high-risk chemical at a current target detecting location; obtaining concentration distribution information of the atmospheric high-risk chemical at a plurality of detecting locations; and

S408, transmitting the concentration distribution information at the plurality of detecting locations to a data processing system to process the concentration distribution information thereby obtaining a spatial distribution image of the atmospheric high-risk chemical.

In one of the embodiments, the detecting device is a terahertz time domain system device.

In one embodiment, the terahertz wave (or signal) is an electromagnetic wave with a frequency in a range from 0.1 THz to 10 THz (wavelength of 3 mm to 30 μm). Terahertz wave is suitable for detecting a lot special materials. In environmental monitoring aspect, terahertz wave is suitable for the study of electrical and acoustic properties of solid, liquid, atmospheric high-risk chemical and fluids, as well as for contaminant detection, detection of biological and chemical substances, and quality control of the food industry.

The terahertz wave has a wide band. The frequency band of a single terahertz wave pulse can range from a few hertzs to several tens of terahertzs. The detecting device can detect the object by using a Fourier transform infrared spectroscopy method, a microwave spectroscopy method, a far-infrared laser, a nonlinear mixing technology, a far-infrared grating spectroscopy or the like. The light source used for forming the terahertz time domain spectrum can be a terahertz pulse with a pulse width on the order of picoseconds, and the time resolution of the terahertz pulse can reach picoseconds. The terahertz time domain spectral measurement is used to measure the electric field of the terahertz pulse, which is a coherence measurement, resulting not only amplitude information, but also phase information, thus a refractive index of the sample can be obtained directly. In addition, for some high-molecular atmospheric high-risk chemical, the absorption peaks of the spectrum obtained by using the terahertz wave is sharper, and fewer overlaps occur between the absorption lines, which are beneficial for the identification of atmospheric high-risk chemical. In particular, many atmospheric high-risk chemicals have unique absorption lines in the terahertz spectrum, and the composition and concentration of the atmospheric high-risk chemicals can be measured by using the terahertz time domain spectroscopy. Meanwhile, terahertz spectroscopy can be used to measure the absorption of different components in mixed atmospheric high-risk chemicals, and determine the chemical composition of the mixed atmospheric high-risk chemicals and the concentration of each component with high accuracy.

Particularly, terahertz waves have good penetrability through many dielectric materials and non-polar liquids compared to other detecting means, so the terahertz waves can be used for see-through imaging of opaque objects. In addition, since a typical wavelength of terahertz waves is much larger than a size of soot particles in air, these suspended soot particles scatter the terahertz wave much less than the scattering of other electromagnetic waves, so the terahertz waves are more suitable in a relatively complex environment.

The terahertz waves have absorption peaks and reflection peaks at different frequencies for different substances which results fingerprint spectrums of the substances, thus the terahertz waves can efficiently and accurately calibrate the species of high-risk chemical in the atmosphere by comparing with the existing fingerprint information of the high-risk chemical in database. The concentration of high-risk chemical in the atmosphere can be determined according to the amplitudes or areas of the absorption peaks or the reflection peaks, or other features of the absorption peaks or the reflection peaks that vary with the concentration of the high-risk chemical in the atmosphere.

Terahertz waves are submillimeter waves, and the photon energy and characteristic temperature of the terahertz waves are very low. Energy of a photon having a frequency of 1 THz (corresponding to 33 cm⁻¹) is 4.1 MeV, and the characteristic temperature thereof is 48K, which is lower than the bond energy of various chemical bonds. The photon energy required for ionizing biological tissues usually reaches 16 eV. The energy of the terahertz waves is far less for ionizing biological tissues or cells, so the terahertz waves may not cause harmful ionization reactions, and suitable for complex environment.

The terahertz time domain system can be transmissive type, reflective type, differential type, ellipsometric type, or the like that is capable of detecting high-risk chemical in the atmosphere. In one embodiment, the terahertz time domain system is a transmissive type terahertz time domain system.

In one embodiment, the method for obtaining the target detecting location in step S404 comprises:

sorting all the obtained concentration distribution information in the three-dimensional coordinates, obtaining a highest concentration point in the three-dimensional coordinates, and determining a direction of the highest concentration point as a traveling direction of the detecting device.

The detecting device then travels in the traveling direction to reach the target detecting location.

The target detecting location is a next location that the detecting device determines to detect according to the detection result at the current location. The three-dimensional coordinates comprises the abscissa x, the ordinate y, and the applicate z. The sorting all the obtained concentration distribution information in the three-dimensional coordinates can be sorting all the concentrations of the atmospheric high-risk chemical obtained in the three-dimensional coordinates from large to small, and obtaining the coordinates of the point with the largest concentration, that is, the coordinates of the target detecting location (x′, y′, z′).

In one embodiment, the sorting all the obtained concentration distribution information in the three-dimensional coordinates of the current location comprises:

using a bubble sorting algorithm to sort all the obtained concentration distribution information in the three-dimensional space at the current location.

In one embodiment, the obtaining the target detecting location according to the concentration distribution information of the atmospheric high-risk chemical, and driving the detecting device to reach the target detecting location comprises:

S4041, sorting all the obtained concentration distribution information in the three-dimensional coordinates of the current location to obtain a direction of a maximum concentration in the three-dimensional space, and determining the direction of the maximum concentration as a traveling direction of the detecting device; and

S4042, driving the detecting device in the traveling direction to reach the target detecting location.

In one embodiment, the sorting all the obtained concentration distribution information in the three-dimensional space of the current location comprises:

using the bubble sorting algorithm to sort all the obtained concentration distribution information in the three-dimensional space at the current location.

The method for sorting all the concentration distribution information obtained in the three-dimensional space of the current location is not limited to bubble sorting, but can be simple sorting, direct insert sorting, hill sorting, heap sorting, merge sorting, quick sorting, or other algorithms that enable the sorting of the concentration distribution information.

In one embodiment, the obtaining the target detecting location according to the concentration distribution information of the atmospheric high-risk chemical, and driving the detecting device to reach the target detecting location further comprises:

S4041′, averaging the concentration distribution information at the same height to obtain average concentrations at different heights at the current location, and obtaining a maximum average concentration in the obtained average concentrations, and determining the height corresponding to the maximum average concentration as a target height z for the detecting device;

S4042′, sorting the concentrations at different angles at the target height, determining an angle corresponding to a maximum concentration at the target height as a target angle for the driving device; and

S4043′, driving the detecting device in a direction having the target height and the target angle to reach the target detecting location.

In one embodiment, the detecting device is used as an origin, the previous traveling direction is used as a reference (i.e., the previous traveling direction is at angle 0°), and the target angle is an angle between the previous traveling direction and a vector from the origin to the target detecting location in a horizontal plane.

In one embodiment of step S408, a plurality sets of concentration distribution information of a certain atmospheric high-risk chemical can be transmitted to a data processing system for processing.

In one embodiment of step S408, the obtaining the spatial distribution image of the atmospheric high-risk chemical according to the concentration distribution information of the atmospheric high-risk chemical at the current location and the concentration distribution information of the atmospheric high-risk chemical at the target detecting locations comprises:

S4081, sending the plurality sets of concentration information corresponding to the three-dimensional coordinates of the certain atmospheric high-risk chemical to a numerical fitting system for numerical fitting, and obtaining a continuously distributed concentration information corresponding to the three-dimensional coordinates of the certain atmospheric high-risk chemical; and

S4082, identifying the continuously distributed concentration information corresponding to the three-dimensional coordinates to obtain a spatial distribution image of the certain atmospheric high-risk chemical.

In one embodiment, the identifying is coloring the continuously distributed concentration information corresponding to the three-dimensional coordinates in different colors. For example, the higher the concentration, the lighter the color, the lower the concentration, the deeper the color. In another example, one species of atmospheric high-risk chemical is indicated in blue, and another species of atmospheric high-risk chemical is indicated in red.

In some embodiments, the identifying can be steps other than the coloring. For example, a text identifying, an image identifying, or other identifying methods that can reflect the concentration information of the atmospheric high-risk chemical can be used to identify the continuously distributed concentration information corresponding to the three-dimensional coordinates.

In one embodiment, after the obtaining the spatial distribution image of the atmospheric high-risk chemical according to the concentration distribution information of the atmospheric high-risk chemical at the current location and the concentration distribution information of the atmospheric high-risk chemical at the target detecting locations, the method further comprises:

S4083, respectively detecting different species of the atmospheric high-risk chemicals through different detecting devices to obtain spatial distribution images of the different species of the atmospheric high-risk chemicals; and

S4084, superposing the spatial distribution images of the different species of the atmospheric high-risk chemicals to obtain a spatial distribution superposed image of the different species of the atmospheric high-risk chemicals, and outputting the spatial distribution superposed image of the different species of the atmospheric high-risk chemicals.

In one embodiment, a computer readable storage medium storing a computer program is also provided. By executing the computer program through a processor, the steps of the methods of any of the above embodiments can be implemented.

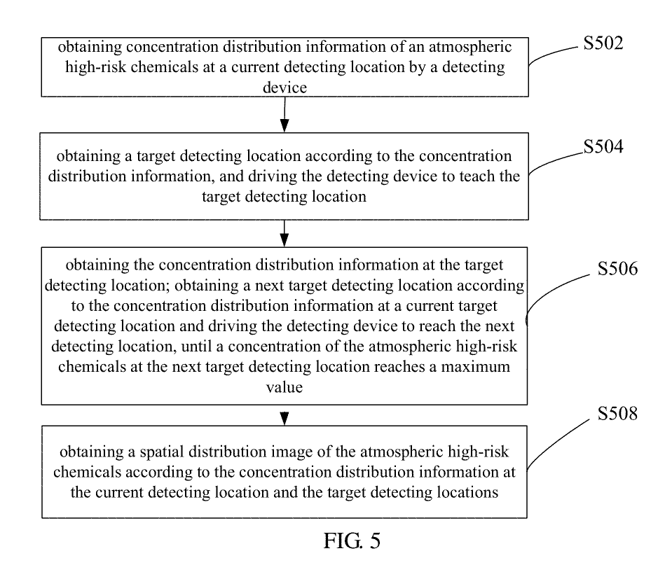

Referring to FIG. 5, a terahertz based method for detecting a single leakage source of an atmospheric high-risk chemical, comprising:

S502, obtaining concentration distribution information of an atmospheric high-risk chemical at a current detecting location by a detecting device;

S504, obtaining a target detecting location according to the concentration distribution information of the atmospheric high-risk chemical, and driving the detecting device to teach the target detecting location;

S506, obtaining the concentration distribution information of the atmospheric high-risk chemical at the target detecting location by the detecting device; obtaining a next target detecting location according to the concentration distribution information of the atmospheric high-risk chemical at a current target detecting location and driving the detecting device to reach the next detecting location, until a concentration of the atmospheric high-risk chemical at the next target detecting location reaches a maximum value, thereby the detecting device reaching a leakage source of the atmospheric high-risk chemical; and

S508, obtaining a spatial distribution image of the atmospheric high-risk chemical according to the concentration distribution information of the atmospheric high-risk chemical at the current detecting location and the concentration distribution information of the atmospheric high-risk chemical at the target detecting locations.

Steps S502, S504, and S508 can be substantially the same with steps S402, S404, and S408.

In particular, in one embodiment of step S506, when the concentration of the atmospheric high-risk chemical at the next target detecting location is a maximum value, the detecting device reaches the atmospheric high-risk chemical leakage source.

The atmospheric high-risk chemical leakage source is a location within an area. A distance between two adjacent detecting locations detected by the detecting device can be set as one step.

In an embodiment, the steps S4041 and S4042 are performed when the atmospheric high-risk chemical leakage source is seen as a sphere range. The origin of the sphere range is the point having the maximum value of the concentration of the atmospheric high-risk chemical, and the radius of the sphere range is the length of the one step.

In an embodiment, the steps S4041′, S4042′ are performed when the atmospheric high-risk chemical leakage source is seen as a circular range. The origin of the circle range is the point having the maximum value of the concentration of the atmospheric high-risk chemical at the corresponding height, and the radius of the circle range is the length of the one step. The method for deciding the atmospheric high-risk chemical leakage source area is not limited to the above two types, and in various cases, various methods can be flexibly adopted.

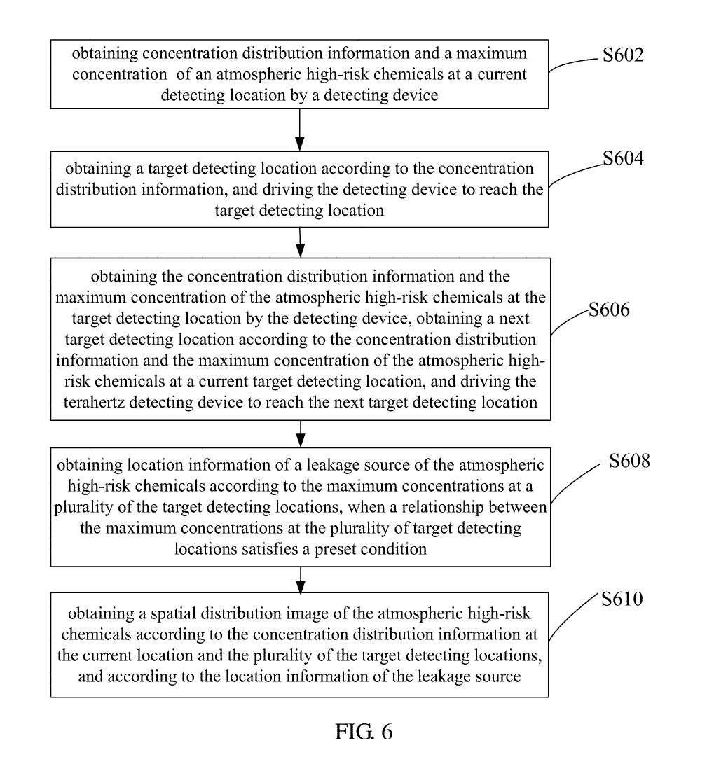

Referring to FIG. 6, a terahertz based method for detecting a single leakage source of an atmospheric high-risk chemical, comprising:

S602, obtaining concentration distribution information and a maximum concentration of an atmospheric high-risk chemical at a current detecting location by a detecting device;

S604, obtaining a target detecting location according to the concentration distribution information of the atmospheric high-risk chemical, and driving the detecting device to reach the target detecting location;

S606, obtaining the concentration distribution information and the maximum concentration of the atmospheric high-risk chemical at the target detecting location by the detecting device, obtaining a next target detecting location according to the concentration distribution information and the maximum concentration of the atmospheric high-risk chemical at a current target detecting location, and driving the terahertz detecting device to reach the next target detecting location;

S608, obtaining location information of a leakage source of the atmospheric high-risk chemical according to the maximum concentrations at a plurality of the target detecting locations, when a relationship between the maximum concentrations at the plurality of target detecting locations satisfies a preset condition; and

S610, obtaining a spatial distribution image of the atmospheric high-risk chemical according to the concentration distribution information of the atmospheric high-risk chemical at the current location and the plurality of the target detecting locations, and according to the location information of the leakage source.

Steps S602, S604, S606, and S610 can be substantially the same as steps S502, S504, S506, and S510.

In one embodiment, the step of obtaining the location information of the leakage source of the atmospheric high-risk chemical according to the maximum concentrations at the plurality of the target detecting locations, when the relationship between the maximum concentrations at the plurality of target detecting locations satisfies a preset condition comprises: comparing the maximum concentrations of the atmospheric high-risk chemical at the current location and at two next target detecting locations directly after the current location; and when the maximum concentrations of the atmospheric high-risk chemical at the two next target detecting locations directly after the current location are both smaller than the maximum concentration of the atmospheric high-risk chemical at the current location, determining the current location as the atmospheric high-risk chemical leakage source.

In one embodiment, the step of obtaining the location information of the leakage source of the atmospheric high-risk chemical according to the maximum concentrations at the plurality of the target detecting locations, when the relationship between the maximum concentrations at the plurality of target detecting locations satisfies a preset condition further comprises:

when the maximum concentration of the atmospheric high-risk chemical at a first target detecting location after the current location is smaller than the maximum concentration of the atmospheric high-risk chemical at the current location, and the maximum concentration of the atmospheric high-risk chemical at the second target location after the current location is greater than the maximum concentration of the atmospheric high-risk chemical at the current location, then further comparing the maximum concentrations of the atmospheric high-risk chemical at the current location and at the third target detecting location after the current location;

when the maximum concentration of the atmospheric high-risk chemical at the third target detecting location after the current location is smaller than the maximum concentration of the atmospheric high-risk chemical at the current location, determining the current location as the atmospheric high-risk chemical leakage source.

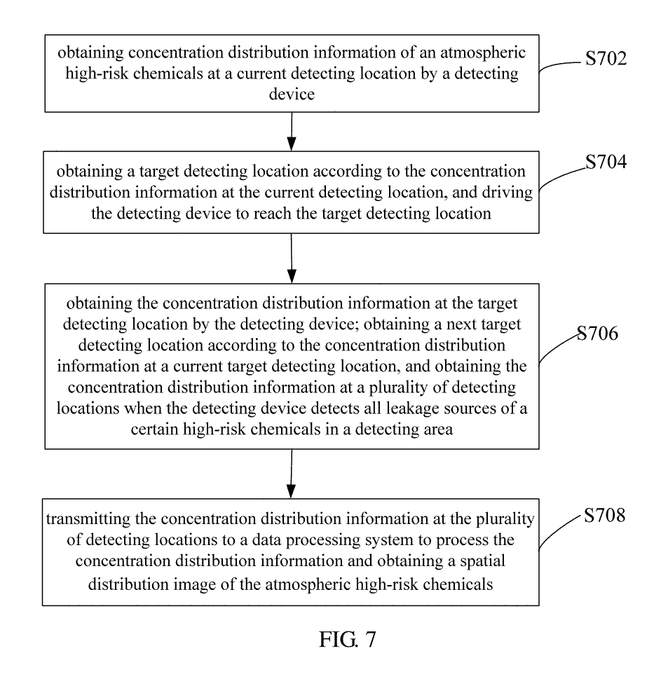

Please refer to FIG. 7, a method for detecting a plurality of leakage sources of an atmospheric high-risk chemical based on terahertz, comprises: S702, obtaining concentration distribution information of an atmospheric high-risk chemical at a current detecting location by a detecting device;

S704, obtaining a target detecting location according to the concentration distribution information of atmospheric high-risk chemical at the current detecting location, and driving the detecting device to reach the target detecting location; S706, obtaining the concentration distribution information of the atmospheric high-risk chemical at the target detecting location by the detecting device;

obtaining a next target detecting location according to the concentration distribution information of the atmospheric high-risk chemical at a current target detecting location, and obtaining the concentration distribution information of the atmospheric high-risk chemical at a plurality of detecting locations when the detecting device detects all leakage sources of a certain high-risk chemical in a detecting area; and

S708, transmitting the concentration distribution information at the plurality of detecting locations to a data processing system to process the concentration distribution information and obtaining a spatial distribution image of the atmospheric high-risk chemical.

Steps S702, S704, and S708 can be substantially the same with steps S602, S604, and S608.

In one embodiment, when all the leak sources of a certain species of atmospheric high-risk chemicals are obtained in an area, the coordinates of the detecting device is an end point.

In one embodiment, the method for determining that all the leak sources of the certain species of atmospheric high-risk chemicals are obtained in the area comprises: obtaining the next target detecting location according to the concentration distribution information of the atmospheric high-risk chemicals at the target detecting location until the coordinates of the next target detecting location coincide with the coordinates of any of the previous detecting locations; and determining that all the leakage sources of a certain atmospheric high-risk chemical in the detection area are obtained by the detecting device.

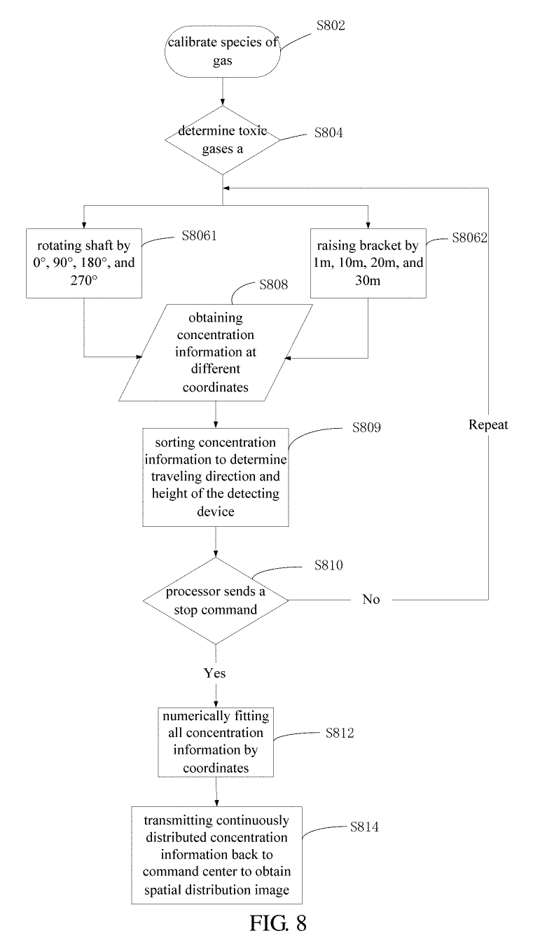

Referring to FIG. 8, in one embodiment, the method for obtaining the next target detecting location according to the concentration distribution information of the atmospheric high-risk chemical at the target detecting location until the coordinates of the next target detecting location coincide with the coordinates of any of the previous detecting locations comprises:

obtaining coordinates of a plurality of target detecting locations and storing the coordinates of the plurality of target detecting locations in the processing system;

the processing system analyzing the obtained coordinates of the plurality of target detecting locations; and

when the processing system detecting the coordinates of the next target detecting location coincides with the coordinates of any of the previous target detecting locations, the processing system sending a stop command, and the detecting device stopping the detecting.

Referring to FIG. 8, one embodiment of a terahertz based method for detecting toxic gas is further provided, comprising:

S802, the detecting device 100 calibrating a gas component to determine the species of three toxic gases a, b, and c in the gas;

S804, measuring the concentration of the toxic gas a; S8061, adjusting the mechanical adjusting device, so that the rotating brackets connected to the rotating shaft are respectively rotated by 0°, 90°, 180°, and 270°;

S8062, raising the height adjusting bracket by 1 m, 10 m, 20 m, and 30 m respectively; S808, obtaining concentration information at different coordinates; S809, sorting the concentration information to determine the traveling direction and the height of the detecting device;

when the processing device sends a stop command, then processing:

S812, numerically fitting all the concentration information with respect to the coordinates;

S814, transmitting the continuously distributed concentration information back to the command center thereby obtaining the spatial distribution image; and

when the processing device does not sends a stop command, then repeating steps S802, S804, S8061, S8062, S808, and S809.

The steps of S802, S804, S8061, S8062, S808, S809, S810, S812, and S814 are repeated to measure the toxic gases b and c, and the concentration distribution information of the toxic gases b and c are obtained, and the concentration distribution matrix of the toxic gases a, b, and c is as follows:

$$( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) ( \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34} \\ {b}_{41} & {b}_{42} & {b}_{43} & {b}_{44}\end{matrix} ) ( \begin{matrix}{c}_{11} & {c}_{12} & {c}_{13} & {c}_{14} \\ {c}_{21} & {c}_{22} & {c}_{23} & {c}_{24} \\ {c}_{31} & {c}_{32} & {c}_{33} & {c}_{34} \\ {c}_{41} & {c}_{42} & {c}_{43} & {c}_{44}\end{matrix} )$$

The concentration of each of the toxic gases a, b, and c is sorted from large to small, such as a23>a13>a33>a43> . . . >a22>a12>a32>a42. It can be seen that x is a certain height in a concentration axy, and y represents an angle direction, thereby the direction of the coordinates 2-3 is determined as the direction in which the concentration of the toxic gas a increases fastest, the height 2 is the height at which the concentration of the toxic gas a is the largest, and the coordinate 4 is the height at which the concentration of the toxic gas a is the smallest. An instruction is sent to the universal wheel 126 to cause the universal wheel 126 to travel in the direction in which the concentration is increasing the fastest, that is, in the direction of −135°. All data is collected, and the discrete concentration is numerically fitted with respect to the coordinates by the processing device 130, thereby obtaining a continuous concentration distribution of the gases a, b, and c with respect to the three-dimensional coordinates.

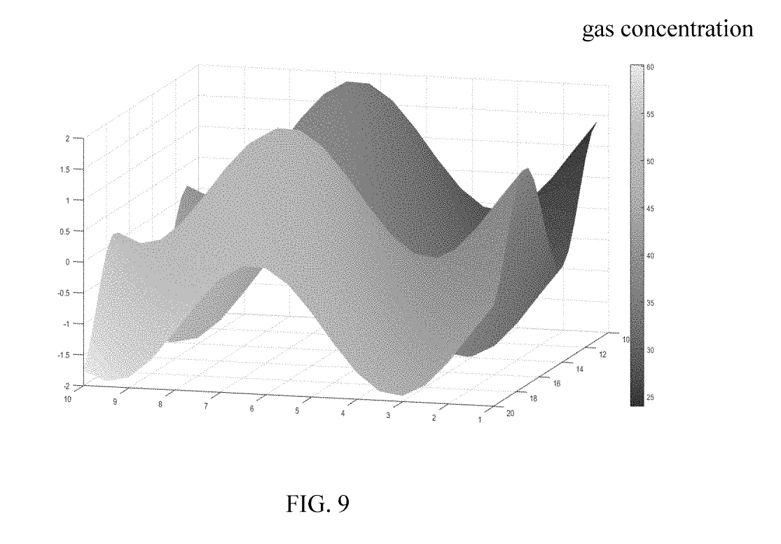

Referring to FIG. 9, which illustrates a distribution diagram of the concentration detection results of toxic gas a, it can be seen through the colorimetric bars that the dark colors indicate low-concentration atmospheric high-risk chemical, and light colors indicate high-concentration atmospheric high-risk chemical, so the light color aggregation position is a location where the concentration of the toxic gas a is relatively high, and it is determined to be the location of the leakage source of the toxic gas a, which should be a suppressing location. It can be determined that the concentration of toxic gas a decreases in the direction from light to dark, so a recommended escape route for the crowd is this direction. The direction from dark to light is the increase direction of the concentration of toxic gas a, which is recommended to be avoided by the crowd.

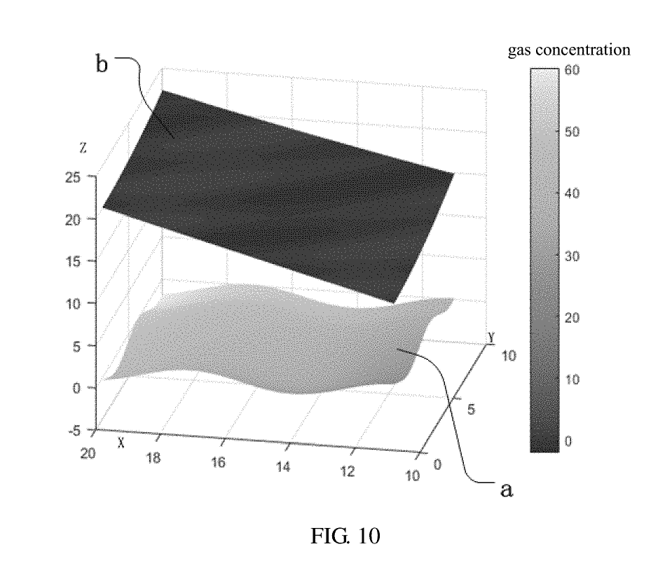

Referring to FIG. 10, which illustrating the distribution of toxic gas a and toxic gas b in a three-dimensional space. It can be seen from the figure that the toxic gas b is distributed at a high altitude, and the toxic gas a is at a low altitude, which is related to the density of the gas itself and the wind power of the day. According to the spatial distribution of different species of gases, the corresponding chemical treatment agents can be effectively sprayed. The toxic gas a at the low altitude has a higher impact on safety of people's life than the toxic gas b at the high altitude. It can be seen from the color depth that the concentration of toxic gas a is larger than that of toxic gas b. Therefore, the leakage of the toxic gas a should be treated first.

Through a visual displaying of FIG. 9 and FIG. 10, the leakage situation of poison gas a and poison gas b can be accurately determined, which helps the commander to make a poison gas suppression scheme and a crowd evacuation scheme.

In one embodiment, the processing device is a computer device comprising a memory and a processor, the memory having a computer program stored therein. When the computer program is executed by the processor, the steps of the methods of any of the above embodiments are implemented.

All or a part of the process of the above embodiments can be implemented by a computer program to instruct related hardware, and the computer program can be stored in a non-volatile computer readable storage. The computer program can be executed as the flow of the methods of the embodiments of as described above. Any reference to a memory, storage, database or other medium used in the various embodiments provided herein can comprise non-volatile and/or volatile memory. Non-volatile memory can comprise read only memory (ROM), programmable ROM (PROM), electrically programmable ROM (EPROM), electrically erasable programmable ROM (EEPROM), or flash memory. Volatile memory can comprise random access memory (RAM) or external cache memory. By way of illustration and not restriction, RAM is available in a variety of forms, such as static RAM (SRAM), dynamic RAM (DRAM), synchronous DRAM (SDRAM), dual data rate SDRAM (DDRSDRAM), enhanced SDRAM (ESDRAM), synchlink DRAM (SLDRAM), memory bus (Rambus), direct RAM (RDRAM), direct memory bus dynamic RAM (DRDRAM), and memory bus dynamic RAM (RDRAM), etc.

It should be noted that relational terms such as first and second are used merely to distinguish one entity or operation from another entity or operation, and do not necessarily require or imply there is any such actual relationship or order between these entities.

Furthermore, the term “comprises” or “includes” or any other variants thereof is intended to encompass a non-exclusive inclusion, such that a process, method, article, or device that comprises a plurality of elements includes not only those elements but also other elements, or elements that are inherent to such a process, method, item, or device. An element that is defined by the phrase “comprising a . . . ” does not exclude the presence of additional equivalent elements in the process, method, item, or device that comprises the element.

The above-mentioned description of the disclosed embodiments enables those skilled in the art to implement or use the present application. Various modifications to these embodiments are obvious to those skilled in the art, and the general principles defined herein may be implemented in other embodiments without departing from the spirit or scope of the application. Therefore, the present application is not limited to the embodiments shown herein, but the broadest scope consistent with the principles and novel features disclosed herein.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A terahertz based self-feedback system for detecting atmospheric high-risk chemical, comprising:
a detecting device configured to detect information of an atmospheric high-risk chemical;
a mechanical adjusting device coupled to the detecting device, the mechanical adjusting device being configured to adjust a height and an orientation of the detecting device to obtain the information of the atmospheric high-risk chemical at different heights and orientations;
a mobile carrying device configured to carry the mechanical adjusting device, and to drive the detecting device to move in a space to obtain the information of the atmospheric high-risk chemical at different locations; and
processing device configured to process the information of the atmospheric high-risk chemical detected by the detecting device, to feedback an instruction thereby controlling the mechanical adjusting device to adjust the height and the orientation of the detecting device, and thereby controlling the mobile carrying device to move, according to a processing result of the information of the atmospheric high-risk chemical; and the processing device being configured for imaging the information of the atmospheric high-risk chemical.

2. The terahertz based self-feedback system of claim 1, wherein the detecting device comprises a transmissive type terahertz time domain system.

3. The terahertz based self-feedback system of claim 2, wherein the detecting device further comprises an air humidity detector.

4. The terahertz based self-feedback system of claim 2, wherein the terahertz time domain system comprises a sampling chamber being in communication with an outside environment, the terahertz time domain system is configured to detect the atmospheric high-risk chemical in the sampling chamber and obtain the information of the atmospheric high-risk chemical.

5. The terahertz based self-feedback system of claim 1, wherein the mobile carrying device comprises a housing, the mechanical adjusting device is mounted on the mobile carrying device, and the processing device is located in the housing.

6. The terahertz based self-feedback system of claim 1, wherein the mechanical adjusting device comprises a height adjusting bracket and a cantilever, the height adjusting bracket is coupled to the mobile carrying device, and one end of the cantilever is coupled to the height adjusting bracket, and another end of the cantilever is coupled to the detecting device.

7. The terahertz based self-feedback system of claim 6, wherein the height adjusting bracket is coupled to the cantilever through a slot defined by the height adjusting bracket and a spring disposed in the slot, the spring and the slot are configured to vertically move the cantilever, thereby varying a height level of the detecting device.

8. The terahertz based self-feedback system of claim 6, wherein the height adjusting bracket is coupled to the mobile carrying device through a rotating shaft.

9. The terahertz based self-feedback system of claim 8, wherein the rotating shaft is configured to be rotated 360° thereby rotating, by 360°, the height adjusting bracket and the detecting device coupled thereto through the cantilever around the rotating shaft.

10. The terahertz based self-feedback system of claim 1, wherein the processing device comprises a data processing module and a control module, and the operation performed by the data processing module comprises a sort operation, a leakage source determination operation, a data fitting operation, an image superposing operation, and a coordinate coincidence determination operation on the information of the atmospheric high-risk chemical, and the control module is configured to send an instruction to the detecting device according to a processing result of the data processing module, and send an instruction to drive the detecting device to move.

11. A terahertz based method for detecting a distribution of an atmospheric high-risk chemical, comprising:
obtaining concentration distribution information of an atmospheric high-risk chemical at a current detecting location by a detecting device;
obtaining a target detecting location according to the concentration distribution information of the atmospheric high-risk chemical, and driving the detecting device to reach the target detecting location;
obtaining the concentration distribution information of the atmospheric high-risk chemical at the target detecting location by the detecting device;
obtaining a next target detecting location according to the concentration distribution information of the atmospheric high-risk chemical at a current target detecting location and driving the detecting device to reach the next target detecting location, until coordinates of the next target detecting location coincide with the coordinates of any of previous detecting locations, thereby obtaining the concentration distribution information of the atmospheric high-risk chemical at a plurality of detecting locations; and
transmitting the concentration distribution information to a data processing system to process the concentration distribution information of the atmospheric high-risk chemical at the plurality of detecting locations, thereby obtaining a spatial distribution image of the atmospheric high-risk chemical.

12. The terahertz based method of claim 11, wherein the detecting device is a terahertz time domain system.

13. The terahertz based method of claim 12, wherein the terahertz time domain system is a transmissive type terahertz time domain system.

14. The terahertz based method of claim 11, wherein the obtaining the target detecting location comprises:
sorting all concentration distribution information in three-dimensional space at the current detecting location, obtaining a highest concentration point in the three-dimensional space, and determining a direction of the highest concentration point as a traveling direction of the detecting device.

15. The terahertz based method of claim 14, wherein the sorting all concentration distribution information in the three-dimensional space at the current detecting location comprises:
using a bubble sorting algorithm to sort the all concentration distribution information in the three-dimensional space at the current detecting location.

16. The terahertz based method of claim 11, wherein the obtaining the target detecting location according to the concentration distribution information of the atmospheric high-risk chemical, and driving the detecting device to reach the target detecting location comprises:
averaging the concentration distribution information at same height to obtain average concentrations at different heights at the current detecting location, and obtaining a maximum average concentration in the average concentrations, and determining the height corresponding to the maximum average concentration as a target height z for the detecting device;
sorting the concentrations at different angles at the target height, determining an angle corresponding to a maximum concentration at the target height as a target angle for the driving device; and
driving the detecting device in a direction having the target height and the target angle to reach the target detecting location.

17. The terahertz based method of claim 11, wherein the transmitting the concentration distribution information to a data processing system to process the concentration distribution information of the atmospheric high-risk chemical at the plurality of detecting locations, thereby obtaining a spatial distribution image of the atmospheric high-risk chemical comprises:
sending a plurality sets of concentration information corresponding to three-dimensional coordinates of the atmospheric high-risk chemical to a numerical fitting system for numerical fitting, and obtaining a continuously distributed concentration information corresponding to the three-dimensional coordinates of the atmospheric high-risk chemical; and
identifying the continuously distributed concentration information corresponding to the three-dimensional coordinates to obtain a spatial distribution image of the certain atmospheric high-risk chemical.

18. The terahertz based method of claim 15, after the obtaining the spatial distribution image of the atmospheric high-risk chemical according to the concentration distribution information of the atmospheric high-risk chemical at the current location and the concentration distribution information of the atmospheric high-risk chemical at the target detecting locations, further comprising:
respectively detecting different species of the atmospheric high-risk chemicals through different detecting devices to obtain spatial distribution images of the different species of the atmospheric high-risk chemicals; and
superposing the spatial distribution images of the different species of the atmospheric high-risk chemicals to obtain a spatial distribution superposed image of the different species of the atmospheric high-risk chemicals, and outputting the spatial distribution superposed image of the different species of the atmospheric high-risk chemicals.

19. The terahertz based method of claim 17, wherein the identifying is coloring the continuously distributed concentration information corresponding to the three-dimensional coordinates in different colors.

20. A terahertz based method for detecting a single leakage source of an atmospheric high-risk chemical, the method comprising:
obtaining concentration distribution information of an atmospheric high-risk chemical at a current detecting location by a detecting device;
obtaining a target detecting location according to the concentration distribution information of the atmospheric high-risk chemical, and driving the detecting device to reach the target detecting location;
obtaining the concentration distribution information of the atmospheric high-risk chemical at a current target detecting location by the detecting device; obtaining a next target detecting location according to the concentration distribution information of the atmospheric high-risk chemical at the current target detecting location; and driving the detecting device to reach the next detecting location, until a concentration of the atmospheric high-risk chemical at the next target detecting location reaches a maximum value; and
obtaining a spatial distribution image of the atmospheric high-risk chemical according to the concentration distribution information of the atmospheric high-risk chemical at the current detecting location and the concentration distribution information of the atmospheric high-risk chemical at the target detecting locations.
